(19) United States
(12) Patent Application Publication
(10) Pub. No.: US 2016/0328493 A1
(43) Pub. Date: Nov. 10, 2016

(54) INFORMATION PROCESSING APPARATUS AND ROUTE SEARCH METHOD

(71) Applicant: FUJITSU LIMITED, Kawasaki-shi (JP)

(72) Inventors: Daichi Shimada, Kawasaki (JP); Masayoshi Hashima, Kawasaki (JP)

(73) Assignee: FUJITSU LIMITED, Kawasaki-shi (JP)

(21) Appl. No.: 15/099,954

(22) Filed: Apr. 15, 2016

(30) Foreign Application Priority Data
May 8, 2015 (JP) 2015-095735

(51) Int. Cl. G06F 17/50

(52) U.S. Cl. CPC G06F 17/50

(57) ABSTRACT

An information processing apparatus includes a storage unit and a processor. The storage unit is configured to store information on an obstacle within a three-dimensional space. The processor is configured to partition the three-dimensional space into an orthogonal grid. The processor is configured to perform a linear search of searching for a last portion of a route proceeding from a start point. The linear search is performed starting with a first grid point or a second grid point. The first grid point is the start point. The second grid point is one of direction change points where the route changes a proceeding direction. The last portion linearly proceeds in one direction until the obstacle is detected. The processor is configured to add a third grid point to the direction change points. The third grid point is passed through by the last portion immediately prior to the detection of the obstacle.

### CROSS-REFERENCE TO RELATED APPLICATION

This application is based upon and claims the benefit of priority of the prior Japanese Patent Application No. 2015-095735, filed on May 8, 2015, the entire contents of which are incorporated herein by reference.

### FIELD

The embodiment discussed herein is related to an information processing apparatus and a route search method.

### BACKGROUND

Virtual product simulators (VPSs) have been developed recently. The virtual product simulator promotes the efficiency of design and development by using a three-dimensional (3D) model generated through 3D computer aided design (CAD). The VPS is used for virtual verification in a design phase of a device (such as a notebook personal computer (PC)) to be designed, more specifically, for designing and verifying a wiring route of a harness in the device to be designed.

The user generates a component model of a product (device to be designed) using the 3D CAD. The VPS generates a 3D model (hereinafter referred to as a harness model) of a harness on the generated component model and then displays the harness model on a display unit. The user may specify a start point, an end point, and a passing point of a connector serving as a harness on the 3D model displayed on the display unit to perform routing of a harness wiring. The VPS generates a harness model along the specified harness wiring route on the component model, and then displays the harness model on the display unit. The user views the display unit to check a positional relationship between the component model and the harness model, in other words, an interference state between the component and the harness, and the length and curvature radius of the harness. The user thus designs the wiring route of the harness using the VPS.

Related techniques are disclosed in, for example, Japanese Laid-open Patent Publication No. 9-050454, Japanese Laid-open Patent Publication No. 2009-199348, and Japanese Laid-open Patent Publication No. 3-062949.

A manual operation to perform routing of a wiring and verification thereof using the VPS takes man-hour, and thus routing and verification is time-consuming. For example, a passing point of a harness may be specified by clicking a mouse button. If a passing point falls within a product, the VPS may generate a sectional view of the product or hide the component model such that the user may view the passing point. For example, when the user specifies a passing point in a narrow space, the VPS avoids an erratic click by displaying a portion of interest of the component model in enlargement, or rotating the component model in a manner such that the passing point is seen.

The VPS may have a function of automatically generating, on the component model within the 3D space, a wiring route of a harness, which is free from interference with an obstacle, from a start point to an end point. The function includes search for a basic route (see FIG. 10) and generation of a harness wiring route (see FIG. 11).

In the search for a basic route, an orthogonal grid is deployed in a 3D space containing a harness, as illustrated in FIG. 10. The start point and the end point of the harness are grid points of the orthogonal grid. A wiring route extending from the start point to the end point and free from interference with an obstacle is searched for and generated, by using a route search technique, as a basic route along the orthogonal grid.

In the generation of a harness wiring route, the generated basic route is converted into a harness model, thereby generating a smooth harness wiring route as illustrated in FIG. 11. With the route search technique, neighboring grid points accessible from the start point are searched for one by one, and grid points free from interference with an obstacle are connected from the start point to the end point as illustrated in FIG. 12 and FIG. 13. The basic route is thus searched for and generated.

When a narrow space is present in the 3D space serving as a wiring target as illustrated in FIG. 12, grid points are deployed in the narrow space by narrowing grid intervals (grid point intervals) as illustrated in FIG. 13. For this reason, the number of grid points serving as targets of the route search increases, leading to an increase in the amount of processing involved in the route search.

Referring to FIG. 14, grid points of the orthogonal grid are deployed at locations closer to the obstacles. The number of grid points serving as targets of the route search is thus reduced, and an amount of processing involved in the route search is also reduced.

Typically, the surface of an obstacle is not in parallel with the grid as illustrated in FIG. 15. By comparison of FIG. 14 with FIG. 15, it is difficult to reduce the number of grid points of the orthogonal grid deployed in locations close to the obstacles. Detecting the surface of an obstacle is difficult and involves a large amount of processing.

When the grid intervals are narrow or when the surface of an obstacle is not parallel with the grid, it is difficult to reduce the amount of processing in the route search and the like, and thus the route search is rather time-consuming. Interactive performance (response performance for an instruction from the user) in the VPS is thus lowered.

### SUMMARY

According to an aspect of the present invention, provided is an information processing apparatus including a storage unit and a processor. The storage unit is configured to store therein information on an obstacle present within a three-dimensional space. The processor is configured to partition the three-dimensional space into an orthogonal grid. The processor is configured to perform, on basis of the information stored in the storage unit, a linear search of searching for a last linear portion of a route proceeding from a start point of the route. The linear search is performed starting with a first grid point of the orthogonal grid or a second grid point of the orthogonal grid. The first grid point is set to be the start point. The second grid point is one of direction change points where the route changes a proceeding direction thereof. The last linear portion linearly proceeds from the first grid point or the second grid point in one direction until the obstacle is detected. The processor is configured to add a third grid point of the orthogonal grid to the direction change points. The third grid point is passed through by the last linear portion immediately prior to the detection of the obstacle.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary functional configuration of an information processing apparatus having a route search function according to an embodiment;

FIG. 2 is a diagram illustrating an exemplary hardware configuration of an information processing apparatus implementing a route search function according to an embodiment;

FIG. 3 is a diagram illustrating a route search method according to an embodiment;

FIG. 4 is a flowchart illustrating route search according to an embodiment;

FIG. 5 is a flowchart illustrating check of an accessible grid point, which is performed for each grid point to be checked in route search of FIG. 4;

FIG. 6 is a flowchart illustrating exception processing performed when an end point is not accessible in route search according to an embodiment;

FIG. 7 is a flowchart illustrating check of an accessible grid point, which is performed for each grid point to be checked in exception processing of FIG. 6;

FIGS. 8A through 8C illustrate search candidates in a first check queue according to an embodiment;

FIG. 9 illustrates a state in which an end point is not accessible in route search according to an embodiment and exception processing performed when the state has occurred;

FIG. 10 illustrates search for a basic route;

FIG. 11 illustrates generation of a harness wiring route;

FIG. 12 illustrates route search using a grid;

FIG. 13 illustrates route search using a grid with narrow grid intervals;

FIG. 14 illustrates route search using grid points deployed close to an obstacle; and

FIG. 15 illustrates locations of grid points deployed close to an obstacle having a surface which is not parallel with a grid line.

### DESCRIPTION OF EMBODIMENT

An information processing apparatus and a route search method according to an embodiment are described in detail with reference to the drawings. The embodiment is described for exemplary purposes only, and is not intended to exclude a variety of modifications and techniques not disclosed in the embodiment. The embodiment may be implemented in a variety of modifications without departing from the scope of the embodiment. Each drawing is not limited to include illustrated elements alone, and may include other elements. The variety of modifications may be combined as long as they are not contradictory to each other.

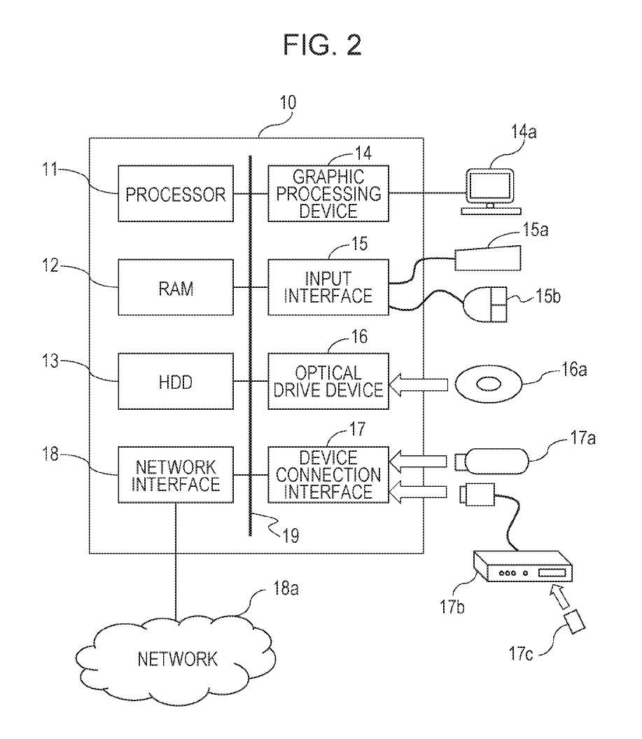

The hardware configuration of an information processing apparatus 10 (computer) implementing a route search function according to the embodiment is described with reference to FIG. 2. FIG. 2 is a diagram illustrating an exemplary hardware configuration of the information processing apparatus 10.

The computer 10 includes a processor 11, a random access memory (RAM) 12, a hard disk drive (HDD) 13, a graphic processing device 14, an input interface 15, an optical drive device 16, a device connection interface 17, and a network interface 18. The elements 11 through 18 are communicably connected with each other via a bus 19.

The processor 11 controls the entirety of the computer 10. The processor 11 may be a multi-processor. The processor 11 may be one of a central processing unit (CPU), a micro processing unit (MPU), a digital signal processor (DSP), an application specific integrated circuit (ASIC), a programmable logic device (PLD), and a field programmable gate array (FPGA). The processor 11 may be a combination of two or more of the CPU, MPU, DSP, ASIC, PLD, and FPGA.

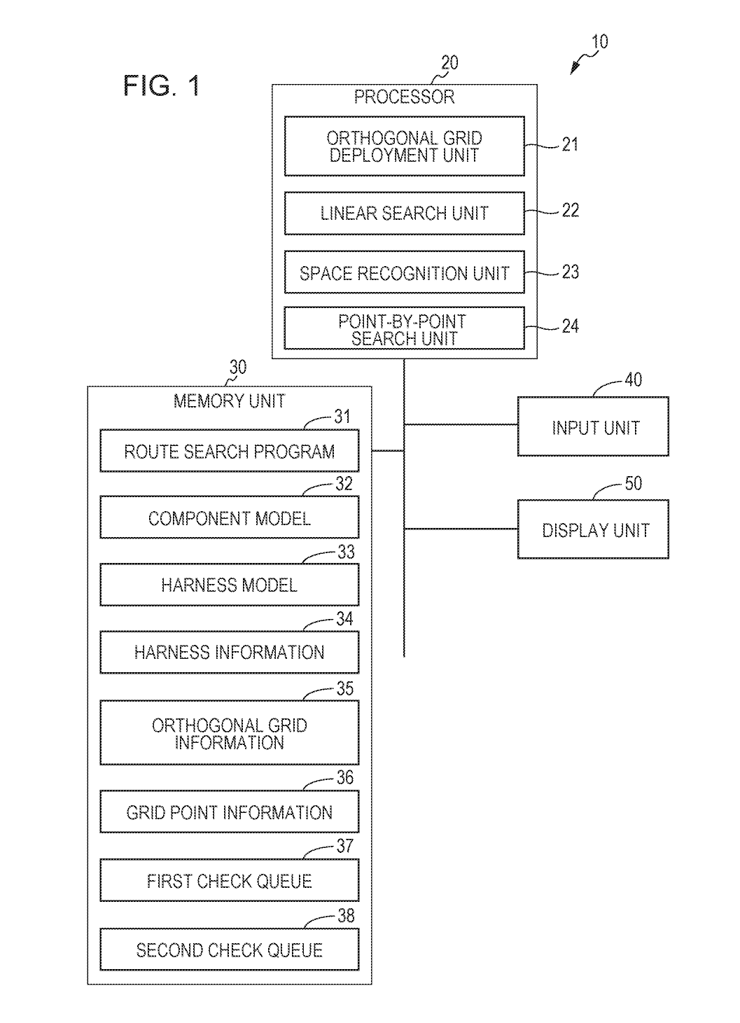

The RAM 12 (memory unit) is used as a main memory of the computer 10. The RAM 12 temporarily stores therein at least part of an operating system (OS) program and application programs to be executed by the processor 11. The RAM 12 also stores therein a variety of data for use in the processing performed by the processor 11. The application programs include a route search program 31 (see FIG. 1) to be executed by the processor 11. The information processing apparatus 10 thus implements the route search function.

The HDD 13 (memory unit) magnetically writes data onto or reads data from a built-in disk. The HDD 13 serves as an auxiliary storage device of the computer 10. The HDD 13 stores therein the OS program, the application programs, and a variety of data. The auxiliary storage device may also be a solid state drive (SSD) such as a flash memory.

The graphic processing device 14 is connected to a monitor 14a. The graphic processing device 14 displays an image on the monitor 14a in response to a command from the processor 11. The monitor 14a may be a display device including a cathode ray tube (CRT) or a liquid-crystal display device.

The input interface 15 is connected to a keyboard 15a and a mouse 15b. The input interface 15 transfers a signal coming from the keyboard 15a or the mouse 15b to the processor 11. The mouse 15b is an example of a pointing device, and other types of pointing device may be used. The other types of pointing device may include a touch panel, a tablet, a touchpad, and a trackball.

The optical drive device 16 reads data recorded on an optical disk 16a using a laser light beam or the like. The optical disk 16a is a portable, non-transitory recording medium on which data is recorded in a manner such that the data is read via a reflected light beam. The optical disk 16a may be a digital versatile disk (DVD), DVD-RAM, compact disk read-only memory (CD-ROM), CD-recordable (CD-R), or CD rewritable (CD-RW).

The device connection interface 17 connects the computer 10 to a peripheral device. For example, the device connection interface 17 is connected to a memory device 17a or a memory reader-writer 17b. The memory device 17a is a non-transitory recording medium having a function of communicating with the device connection interface 17. For example, the memory device 17a may be a universal serial bus (USB) memory. The memory reader-writer 17b writes data onto a memory card 17c, or reads data from the memory card 17c. The memory card 17c is a non-transitory card-type recording medium.

The network interface 18 is connected to a network 18a. The network interface 18 transmits data to or receives data from another computer or a communication device via the network 18a.

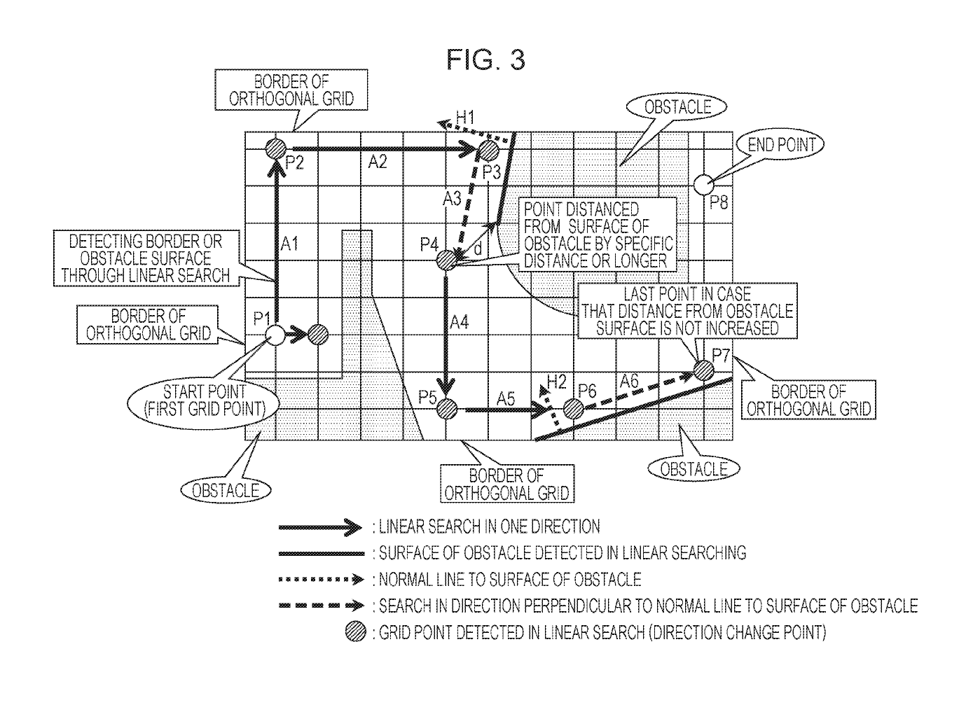

The computer 10 having the hardware configuration described above implements a route search function according to the embodiment as described later with reference to FIG. 3 through FIG. 9.

The computer 10 implements the route search function according to the embodiment by executing a program (route search program or the like) recorded on a non-transitory computer-readable recording medium. The program describing contents of processing to be performed by the computer 10 may be recorded on one of a variety of recording media. For example, the program to be executed by the computer 10 may be stored in the HDD 13. The processor 11 loads at least part of the program in the HDD 13 onto the RAM 12, and executes the loaded program.

The program to be executed by the computer 10 (processor 11) may be recorded on a non-transitory portable recording medium, such as the optical disk 16a, the memory device 17a, or the memory card 17c. The program stored in the portable recording medium may be installed in the HDD 13 under the control of the processor 11 and is then executed. The processor 11 may directly read the program from the portable recording medium and then execute the read program.

Referring to FIG. 1, the functional configuration of the information processing apparatus 10 (computer) having the route search function according to the embodiment is described below. FIG. 1 is a diagram illustrating an exemplary functional configuration of the computer 10.

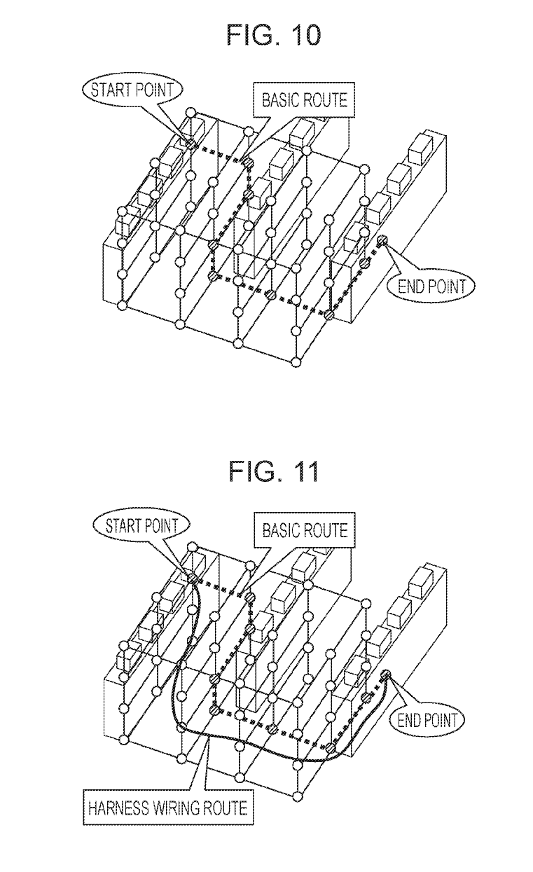

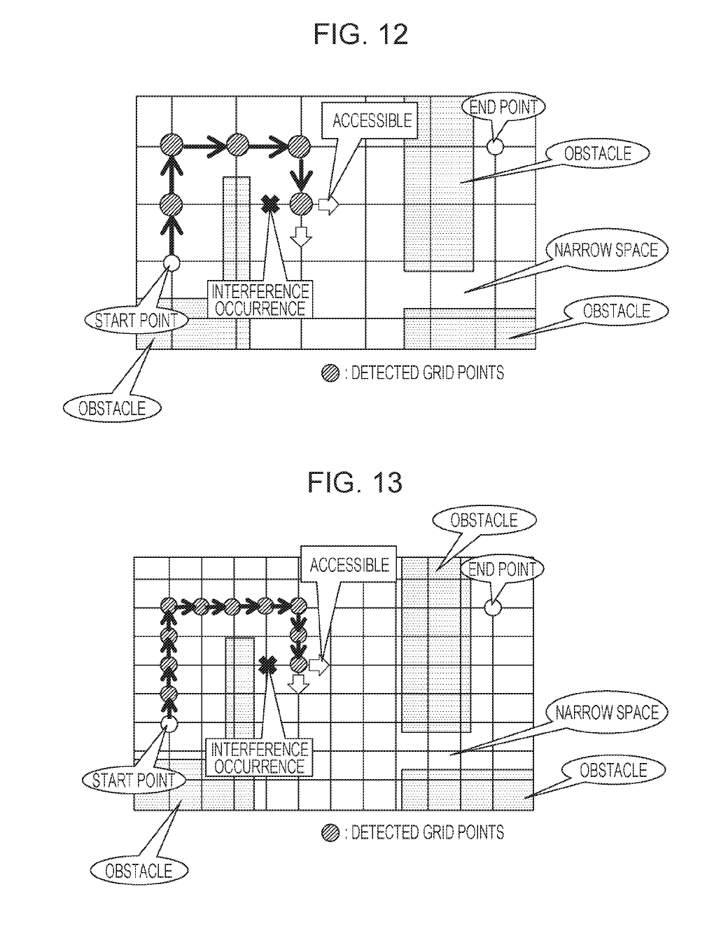

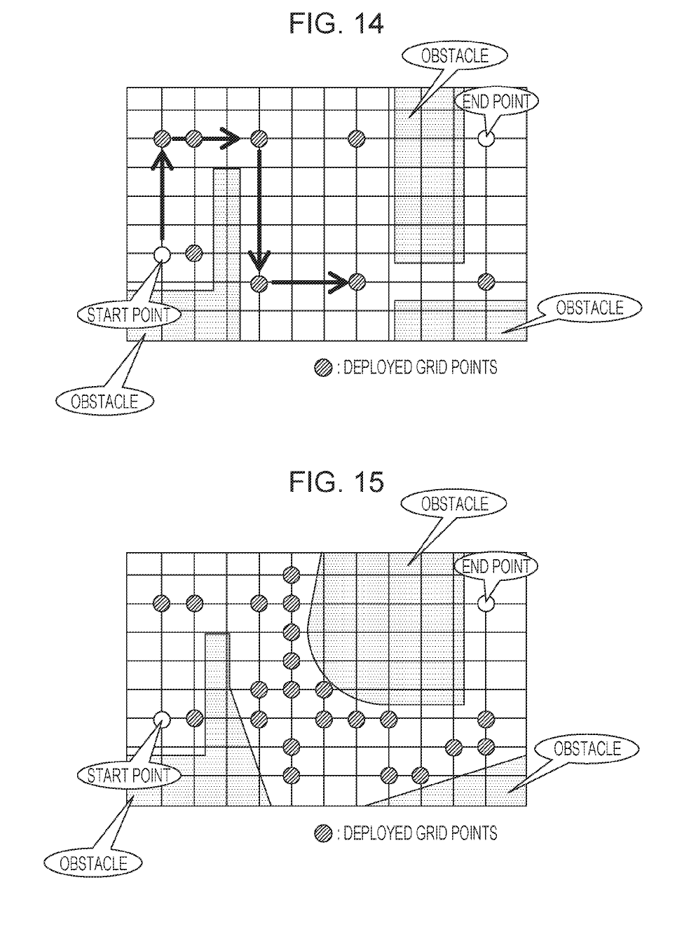

The computer 10 performs the search for the basic route (see FIG. 10). The computer 10 searches for and generates, as a basic route, a wiring route that extends from a start point to an end point in a 3D space where borders and obstacles are present, and is free from interference with the obstacles. For example, the borders in the embodiment are borders of the orthogonal grid that is deployed as described later with reference to FIG. 3. To implement this, the computer 10 has functions of at least a processor 20, a memory unit 30, an input unit 40, and a display unit 50 as illustrated in FIG. 1.

The processor 20 is, for example, the processor 11 as illustrated in FIG. 2. By executing the route search program 31, the processor 20 implements functions of an orthogonal grid deployment unit 21, a linear search unit 22, a space recognition unit 23, and a point-by-point search unit 24 described later.

The memory unit 30 may be the RAM 12 or the HDD 13 as illustrated in FIG. 2, and stores therein a variety of information to implement the route search function. The variety of information includes, in addition to the route search program 31, a component model 32, a harness model 33, harness information 34, orthogonal grid information 35, grid point information 36, a first check queue 37, and a second check queue 38.

The component model 32 is a 3D model of a product (device to be designed) and generated using the 3D CAD. The computer 10 according to the embodiment wires a harness from a start point to an end point, specified by the user, on the component model 32.

The harness model 33 is a 3D model of a harness wired on the component model 32 by the computer 10 according to the embodiment. The harness model 33 is generated by converting the basic route detected and generated by the route search function of the computer 10 according to the embodiment. The harness model 33 corresponds to a smooth harness wiring route (see FIG. 11).

The harness information 34 is information on a harness to be wired on the component model 32. For example, the harness information 34 includes information concerning the length and the minimum curvature radius of the harness to be wired, and positional information of a start point (first grid point) and an end point (fourth grid point) of the harness to be wired, which are specified by the user. The minimum curvature radius of the harness to be wired is used as a minimum straight travel distance per single linear search to be described later.

The orthogonal grid information 35 (border information) is information on the orthogonal grid deployed as described later with reference to FIG. 3. For example, the orthogonal grid information 35 includes a grid partition number, grid intervals, a deployment direction of the orthogonal grid, and locations of borders of the orthogonal grid.

The grid point information 36 is information on each grid point searched for by the computer 10, and is associated with a grid point identification (ID) identifying the grid point. The grid point information 36 includes positional information (coordinates) of each grid point, a parent grid point ID (hereinafter also simply referred to as “parent”), a cost value with which the basic route reaches each grid point, and a collision flag.

The parent grid point ID identifies a parent grid point that is deployed immediately before the relevant grid point on the basic route which reaches the relevant grid point.

The cost value is defined such that the shorter the travel distance, the smaller the cost value. For example, the cost value is calculated on the basis of a distance D1 (passed grid count) of the basic route from the start point to each grid point, and an estimated distance D2 from each grid point to the end point (such as Manhattan distance). The cost value may be the distance D1 or the distance (D1+D2).

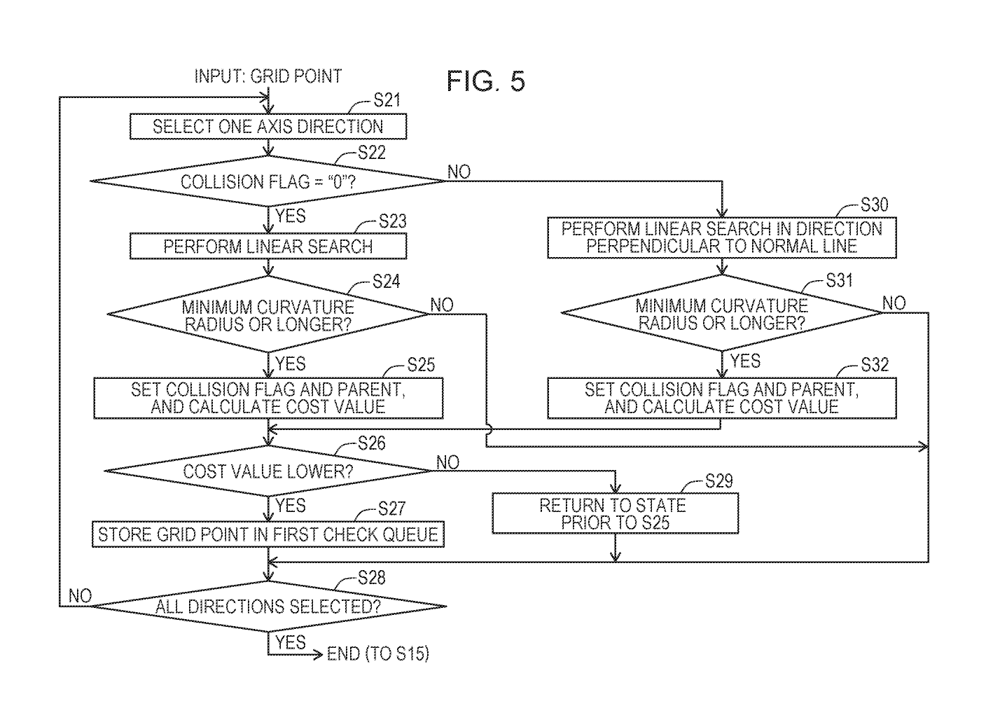

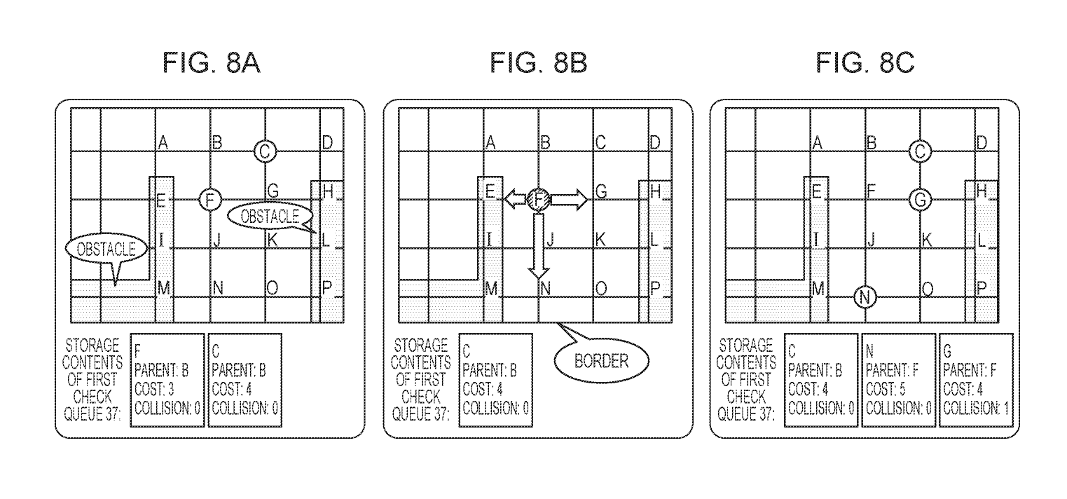

The collision flag is set to “1” for a grid point (third grid point) reached immediately prior to the detection of an obstacle through the linear search (immediately prior to the collision with the obstacle), and otherwise, the collision flag is set to be “0” (see FIG. 5 and FIGS. 8A through 8C).

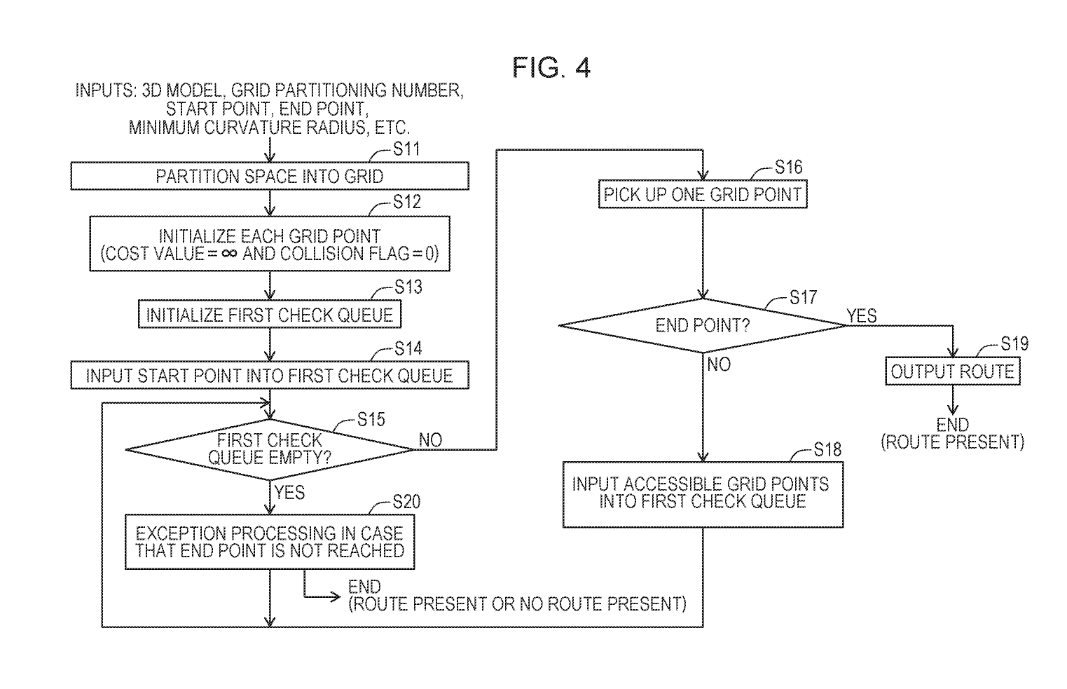

The first check queue 37 is used in the linear search performed by the linear search unit 22 described later. Information (grid point ID, the parent, the cost value, and the collision flag) on a grid point serving as a search candidate to be checked by the linear search unit 22 is input into and temporarily stored in the first check queue 37 (see FIG. 4, FIG. 5, and FIGS. 8A through 8C).

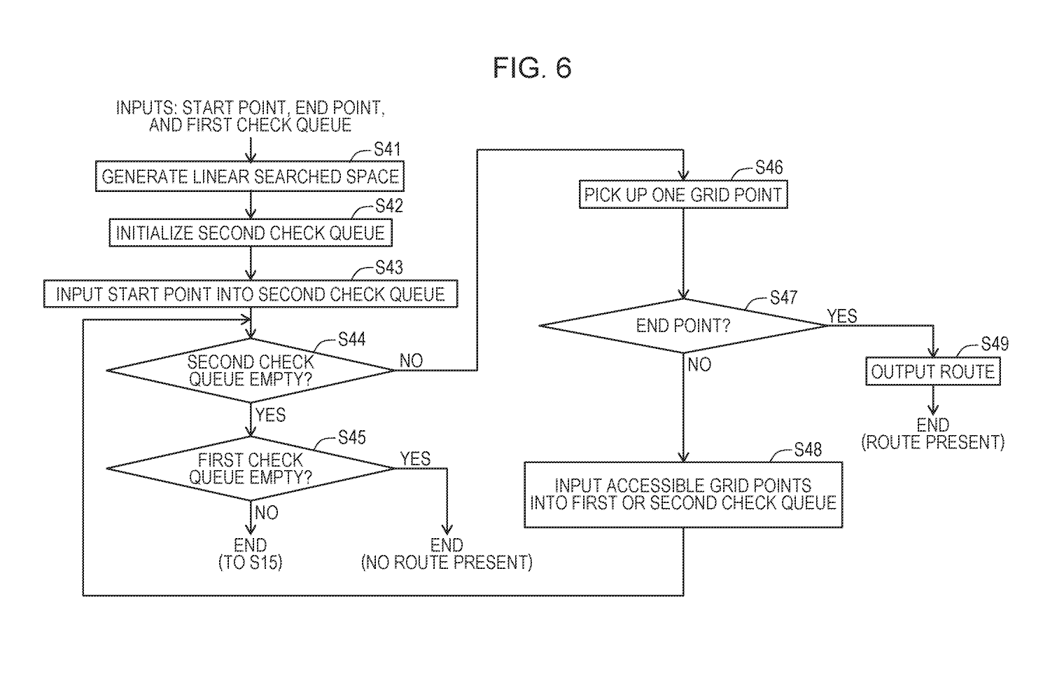

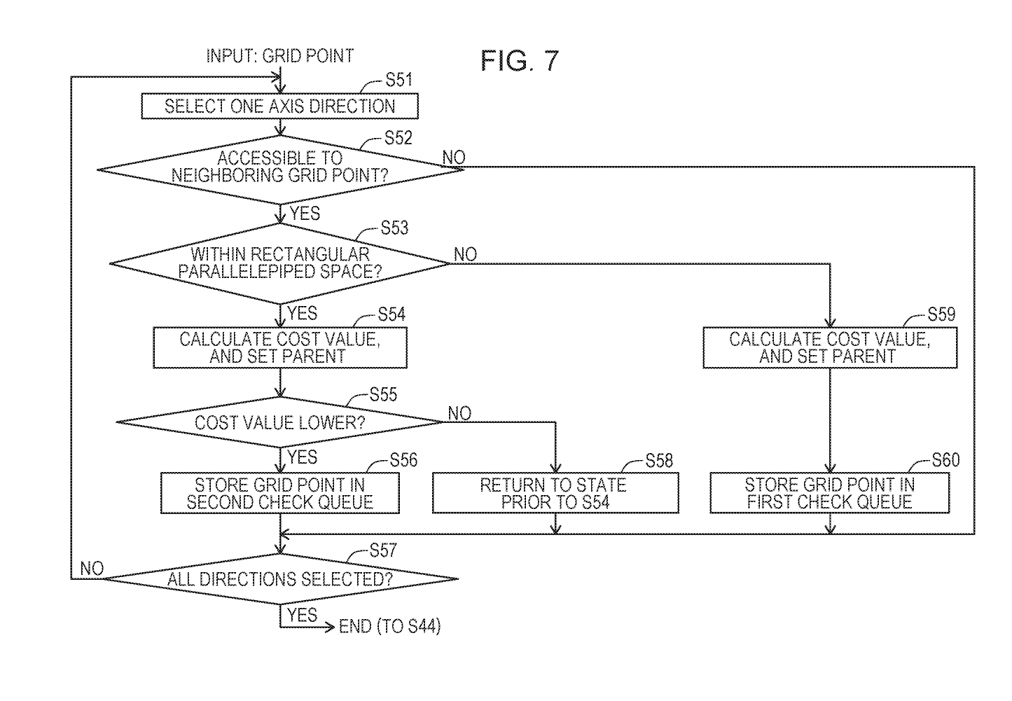

The second check queue 38 is used in the route search performed by the point-by-point search unit 24 described later. Information (grid point ID, the parent, and the cost value) on a grid point serving as a search candidate to be checked by the point-by-point search unit 24 is input into and stored in the second check queue 38 (see FIG. 6 and FIG. 7). When the point-by-point search unit 24 performs the route search using the second check queue 38, the location of each grid point searched for by the point-by-point search unit 24, the parent of each grid point, and the cost value of a search route up to each grid point are stored as the grid point information 36 in the memory unit 30.

The input unit 40 may be the keyboard 15a and the mouse 15b as illustrated in FIG. 2. The input unit 40 is operated by the user to issue a variety of instructions. A touch panel, a tablet, a touchpad, a trackball, or the like may be used instead of the mouse 15b. The user may specify the start point and end point of a harness to be wired on the component model 32 (see FIG. 3) by operating the input unit 40.

The display unit 50 may be the monitor 14a as illustrated in FIG. 2, for example. When the user wires a harness on the component model 32 by using the computer 10 according to the embodiment, the display unit 50 displays a variety of statuses in progressive phases of wiring the harness. For example, the variety of statuses include the status of the search for the basic route (see FIG. 3 and FIG. 10), and the status of the conversion of the basic route into the harness model 33 (see FIG. 11).

As described above, the route search program 31 causes the processor 20 (processor 11) to perform the processing of the orthogonal grid deployment unit 21, the linear search unit 22, the space recognition unit 23, and the point-by-point search unit 24.

The processor 20 (processor 11) implements the functions of the orthogonal grid deployment unit 21, the linear search unit 22, the space recognition unit 23, and the point-by-point search unit 24. These functions are described later.

The orthogonal grid deployment unit 21 (partitioning unit) partitions a 3D space into an orthogonal grid by deploying the orthogonal grid in the 3D space (on the component model 32) in which a harness is wired on the basis of the orthogonal grid information 35. As illustrated in FIG. 3 and FIG. 10, the start point and end point of a harness to be wired, which are specified by the user, are grid points of the orthogonal grid.

The linear search unit 22 proceeds straight ahead from the start point (first grid point of the orthogonal grid illustrated as P1 in FIG. 3) or a grid point (second grid point of the orthogonal grid illustrated as P2, P4, P5, or P7 in FIG. 3) that is detected and set to be a direction change point where the route changes the direction thereof in the linear search, in one axis direction (of six directions) of the orthogonal grid, until a border of the orthogonal grid or an obstacle is detected. The linear search unit 22 thus performs the linear search to search the route.

The linear search unit 22 sets a grid point (third grid point illustrated as P2, P3, P5, or P6 in FIG. 3) of the orthogonal grid that has been passed immediately prior to the detection of the border of the orthogonal grid or the obstacle, to be a next direction change point of the route under search in the grid point information 36 of the memory unit 30. The location of the next direction change point, the parent, the cost value, and the collision flag “1” are set as the information of the next direction change point in the grid point information 36.

When the linear search unit 22 detects a grid point (fifth grid point illustrated as P7 in FIG. 3) at a location where the route under search intersects an axis (one axis of the orthogonal grid) passing through the end point (fourth grid point of the orthogonal grid illustrated as P8 in FIG. 3), the linear search unit 22 sets the detected fifth grid point to be a next direction change point of the route under search in the grid point information 36 in the memory unit 30. In this case, the location of the next direction change point, the parent, the cost value, and the collision flag “0” are set to be the information of the next direction change point in the grid point information 36.

The linear search unit 22 performs the linear search from the direction change point (see P3 or P6 in FIG. 3) in four directions perpendicular to a normal line direction to the surface of the obstacle at the location where the obstacle has been detected (see directions H1 or H2 in FIG. 3) until the minimum distance (see d in FIG. 3) between the surface of the obstacle and the route under search becomes a predetermined distance or longer. The four search directions include two directions that are perpendicular to each other on a plane defined by the normal line direction and the linear search direction extending to the detection of the direction change point (for example, a direction A3 and a direction opposite to the direction A3 or a direction A6 and a direction opposite to the direction A6). The four search directions also include two directions that are perpendicular to the plane defined by the normal line direction and the linear search direction extending to the detection of the direction change point (for example, two directions perpendicular to the page of FIG. 3).

The linear search unit 22 sets, to be a next direction change point of the route under search in the grid point information 36 in the memory unit 30, a grid point (sixth grid point illustrated as P4 in FIG. 3) of the orthogonal grid having a minimum distance to the surface of the obstacle equal to or longer than the minimum curvature radius in a region close to a location where the minimum distance between the surface of the obstacle and the route under search is equal to or longer than the predetermined distance. The location of the next direction change point, the parent, the cost value, and the collision flag “0” are set to be the information of the next direction change point in the grid point information 36.

If the minimum distance between the surface of the obstacle and the route under search remains shorter than the predetermined distance through the linear search, the linear search unit 22 sets a grid point (seventh grid point illustrated as P7 in FIG. 3) of the orthogonal grid closer to the location where the route reaches in the linear search to be a next direction change point of the route under search in the grid point information 36 in the memory unit 30. The location of the next direction change point, the parent, the cost value, and the collision flag “0” are set to be the information of the next direction change point in the grid point information 36.

The linear search unit 22 sets a minimum straight travel distance per linear search from the start point (illustrated as P1 in FIG. 3) or from the direction change point (one of P2 through P7 in FIG. 3) depending on a minimum curvature radius of the harness wired along the route under search. For example, the linear search unit 22 sets the minimum straight travel distance per linear search to be equal to or longer than the minimum curvature radius of the harness wired along the route under search such that the harness is wired along the basic route detected by the linear search unit 22 (as is described later in detail with reference to FIG. 5).

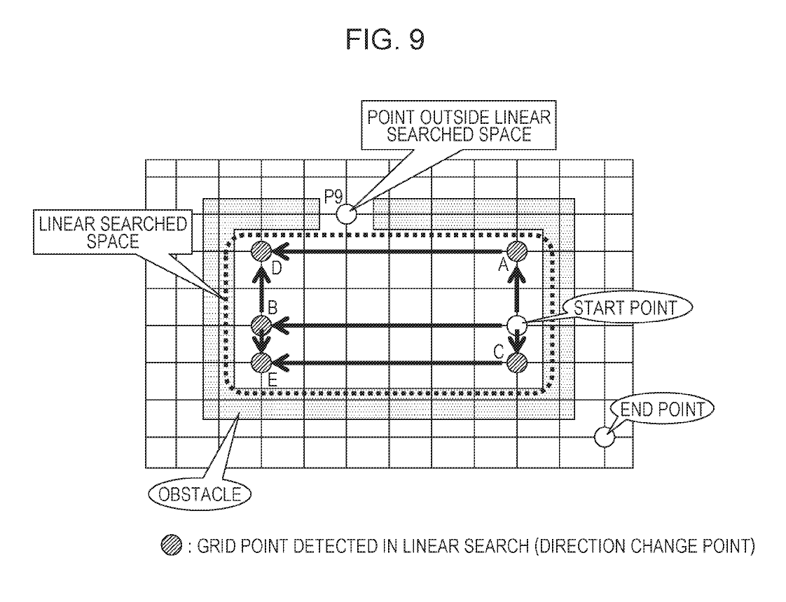

A specific linear search operation that the linear search unit 22 performs using the first check queue 37 is described later with reference to FIG. 4, FIG. 5, FIGS. 8A through 8C, and FIG. 9.

If the route under search fails to reach the end point (like the case that is described later with reference to FIG. 9), the space recognition unit 23 recognizes a linear searched space (see a rectangular parallelepiped space in FIG. 9) that has undergone the linear search.

The point-by-point search unit 24 searches for neighboring grid points, one by one, accessible from the start point within the linear searched space recognized by the space recognition unit 23. The point-by-point search unit 24 then determines whether the detected neighboring grid point is within the linear searched space. The point-by-point search unit 24 sets a neighboring grid point determined to be outside the linear searched space to be a grid point (eighth grid point illustrated as P9 in FIG. 9) on a route extending from within the linear searched space to outside the linear searched space in the grid point information 36 in the memory unit 30. The location of the next direction change point, the parent, and the cost value are set to be the information of the neighboring grid point (eighth grid point) in the grid point information 36. The linear search unit 22 resumes the linear search, starting with the neighboring grid point (eighth grid point).

If the grid point (eighth grid point) on the route extending from within the linear searched space to outside the linear searched space is not detected, or the grid point (eighth grid point) is not present, the point-by-point search unit 24 determines that there is no route extending from within the linear searched space to outside the linear searched space and notifies the user that there is no route, using the display unit 50 or the like.

A specific route search operation that the point-by-point search unit 24 performs using the first check queue 37 and the second check queue 38 is described later with reference to FIG. 6, FIG. 7, and FIG. 9.

The route search method according to the embodiment is described below with reference to FIG. 3. FIG. 3 is a diagram illustrating the route search method according to the embodiment. In FIG. 3, an orthogonal grid deployed in a 3D space in which a harness is to be wired, an obstacle, a start point, an end point, a search route, and a direction of travel in search in the 3D space are illustrated two-dimensionally.

In the route search method according to the embodiment, when the route search (search for the next grid point) begins from the start point (first grid point) or from the second grid point, one of six directions from the beginning point is selected as a direction of travel of the route. As illustrated in FIG. 3, the route search (linear search) is performed in the selected direction of travel to detect a border of the orthogonal grid or an obstacle. When a border is detected, a grid point passed through immediately prior to the detection of the border is set to be a next direction change point (with the collision flag set to be “0”). When an obstacle is detected, a grid point passed through immediately prior to the detection of the obstacle is set to be a next direction change point (with the collision flag set to be “1”). In order to generate a route (basic route) in view of the curvature of the harness, the next direction change point is searched for at a location away from the beginning point by a distance of at least a minimum curvature radius of the harness.

When an obstacle is detected in the route search method according to the embodiment, the linear search is performed from the grid point immediately prior to the detection of the obstacle in a direction perpendicular to the normal line direction to the surface of the obstacle at the location where the obstacle has been detected until the minimum distance between the edge of the surface of the obstacle and the route becomes equal to or longer than a predetermined distance as illustrated in FIG. 3. When a location where the minimum distance between the surface of the obstacle and the route under search is equal to or longer than the predetermined distance is detected, a grid point at a location which is in the vicinity of the detected location and which has a minimum distance from the surface of the obstacle equal to or longer than the predetermined distance is set to be a next direction change point (with the collision flag set to be “0”) of the route under search as illustrated in FIG. 3.

In the route search method according to the embodiment, the linear search to travel consecutively in one direction is performed in six directions. When a border or an obstacle is detected, a direction change point is set. When the surface (curve or a slope) of the obstacle is not parallel with the grid, the linear search is performed in a direction perpendicular to the normal line to the surface of the obstacle until the distance from the surface of the obstacle increases by a predetermined distance. In this way, the obstacle is avoided.

The route search method according to the embodiment reduces the amount of processing to search the route from the start point to the end point in comparison with the route search method in which neighboring grid points are checked one by one to search for the route. Since the route search is performed by selecting only a grid point that is present close to but reliably avoids the obstacle, the amount of processing for the route search from the start point to the end point is reduced even if the grid interval is small and the surface of the obstacle is not parallel with the grid.

The search for a single basic route from the start point P1 (first grid point) to the end point P8 (fourth grid point) in FIG. 3 through the route search method according to the embodiment is described.

The linear search proceeding upward (in a direction A1) from the start point P1 as illustrated in FIG. 3 starts. The linear search proceeds in the direction A1 until the top side border of the orthogonal grid in FIG. 3 is detected. When the top side border is detected, a grid point P2 (third grid point) passed immediately prior to the detection of the top side border is set to be a next direction change point subsequent to the start point P1.

The linear search proceeds rightward (in a direction A2) from the grid point P2 (second grid point) in parallel with the top side border. The linear search proceeds in the direction A2 until the surface of an upper obstacle in FIG. 3 is detected. When the surface of the upper obstacle is detected, a grid point P3 (third grid point) passed immediately prior to the detection of the surface of the upper obstacle is set to be a next direction change point subsequent to the grid point P2.

The linear search proceeds from the grid point P3 in a direction (direction A3) that is perpendicular to the normal line H1 to the surface of the obstacle at the location where the upper obstacle is detected. The linear search proceeds in the direction A3 until a location where a minimum distance d between the surface of the upper obstacle and the route under search is equal to or longer than the minimum curvature radius is detected. When a location where the minimum distance d is equal to or longer than the predetermined distance is detected, a grid point P4 (sixth grid point) of the orthogonal grid at a location which is in the vicinity of the detected location and which has a minimum distance from the surface of the upper obstacle equal to or longer than the predetermined distance d is set to be a next direction change point subsequent to the grid point P3.

The linear search proceeds downward (in a direction A4) from the grid point P4 (second grid point) as illustrated in FIG. 3. The linear search proceeds in the direction A4 until a bottom border of the orthogonal grid in FIG. 3 is detected. When the bottom border of the orthogonal grid is detected, a grid point P5 (third grid point) passed immediately prior to the detection of the bottom border of the orthogonal grid is set to be a next direction change point subsequent to the grid point P4.

The linear search proceeds from the grid point P5 (second grid point) in a rightward direction in parallel with the bottom border (in a direction A5). The linear search proceeds in the direction A5 until a bottom right obstacle in FIG. 3 is detected. When the bottom right obstacle is detected, in other words, when a filled circle representing a grid point falls within an interference range with the surface of the right bottom obstacle, a grid point P6 (third grid point) passed immediately prior to the interference with the surface of the bottom right obstacle is set to be a next direction change point subsequent to the grid point P5.

The linear search proceeds from a grid point P6 in a direction A6 perpendicular to a normal line H2 to the surface of the bottom right obstacle at a location where the bottom right obstacle is detected. When the linear search proceeds in the direction A6, the minimum distance d between the surface of the bottom right obstacle and the route under search remains shorter than the predetermined distance. The route through the linear search reaches the right-hand side border of the orthogonal grid, and a grid point P7 (seventh grid point) close to the right-hand side border is set to be a next direction change point subsequent to the grid point P6.

Alternatively, the grid point P7 may be searched for from the grid point P6 as described below. The linear search may proceed from the grid point P6 in the direction A6, and the grid point P7 may be detected as a grid point (fifth grid point) at a location where the linear search intersects an axis (one axis of the orthogonal grid) passing through the end point P8 (fourth grid point).

Finally, the linear search proceeds from the grid point P7 (second grid point) in an upward direction as illustrated in FIG. 3, thereby detecting the end point P8. The search for a single basic route is thus complete. When multiple different basic routes are detected in a similar fashion, a basic route having a minimum cost value calculated therefor is selected. The cost value herein may be a distance (number of intermediate grid points) of each basic route extending from the start point to the end point.

The route search performed by the computer 10 according to the embodiment is described below with reference to FIG. 4 through FIG. 9.

FIG. 4 is a flowchart illustrating the route search performed by the computer 10 according to the embodiment. The computer 10 receives a 3D model (component model 32), a grid partition number, a start point, an end point, a minimum curvature radius of a harness, and the like, and partitions the 3D space of the component model 32, where a harness is to be wired, into a grid (orthogonal grid) in accordance with the grid partition number (S11).

The linear search unit 22 initializes the grid point information 36 on each grid point of the orthogonal grid partitioned in S11 (S12). More specifically, the cost value and the collision flag stored in association with the grid point ID are respectively set to be (maximum value), and “0”. The location and the parent stored in association with each grid point ID are set to be unfixed.

The linear search unit 22 initializes (sets to be empty) the first check queue 37 in which search candidate grid points in the search performed by the linear search unit 22 are to be input (S13). The linear search unit 22 inputs the start point into the first check queue 37 (S14). The grid point information 36 on the start point is set to the cost value=∞, the collision flag=“0”, and the parent=“none”.

The linear search unit 22 determines whether the first check queue 37 is empty (S15). If the first check queue 37 is not empty (No in S15), the linear search unit 22 picks up a grid point from the first check queue 37 (S16). The linear search unit 22 determines whether the picked-up grid point is the end point (S17).

If the picked-up grid point is not the end point (No in S17), the linear search unit 22 checks an area surrounding the picked-up grid point and inputs, in the first check queue 37, grid points accessible from the picked-up grid point (S18). If there is no grid point accessible from the picked-up grid point, no grid point is input into the first check queue 37. The linear search unit 22 then returns to S15. The check processing in S18 is described later in detail with reference to FIG. 5.

If the picked-up grid point is the end point (Yes in S17), the linear search unit 22 traces back the basic route from the end point by tracing the parents in the grid point information 36, acquires the basic route from the start point to the end point, and outputs the basic route (S19). The linear search unit 22 ends the route search with “route present”. In S19, the user may manually adjust the acquired basic route as appropriate.

If the first check queue 37 is empty (Yes in S15), the computer 10 is determined to stay in a state unable to reach the end point as described later with reference to FIG. 9. In such a case, the computer 10 shifts from the processing performed by the linear search unit 22 to exception processing (corresponding to the state unable to reach the end point) performed by the space recognition unit 23 and the point-by-point search unit 24 in S20.

When a grid point as a search candidate of the search performed by the linear search unit 22 is input into the first check queue 37 in the exception processing in S20, the computer 10 shifts from the exception processing performed by the space recognition unit 23 and the point-by-point search unit 24 to the processing in S15 performed by the linear search unit 22. The computer 10 may end the route search with “route present” or “no route present” in response to as a result of the exception processing in S20 as described later with reference to FIG. 6. The exception processing in S20 is described later in detail with reference to FIG. 6 and FIG. 7.

The check of an accessible grid point, which is performed on each grid point to be checked (search candidate) in S18 in FIG. 4, is described with reference to a flowchart of FIG. 5.

When a grid point (grid point to be checked) that is not the end point picked up in S16 in FIG. 4 is input as an input grid point, the linear search unit 22 selects one axis direction from the six axis directions of the orthogonal grid (fore-aft, lateral, and vertical directions) as a direction in which the linear search proceeds from the input grid point (S21).

The linear search unit 22 references the grid point information 36, and determines whether the collision flag of the input grid point is “0” (S22). If the input grid point is set when the intersection with the border of the orthogonal grid or an axis passing through the end point is detected, the collision flag of the input grid point is “0” (Yes in S22). In such a case, the linear search unit 22 performs the linear search in the one axis direction selected in S21 (S23). More specifically, the linear search unit 22 performs the linear search in the selected one axis direction until the border of the orthogonal grid or the surface of the obstacle is detected or until a grid point at the location intersecting the axis passing through the end point is detected.

If the border of the orthogonal grid or the surface of the obstacle is detected or the grid point at the location intersecting the axis passing through the end point is detected, the linear search unit 22 determines whether the travel distance is equal to or longer than a minimum curvature radius of the harness to be wired (S24). The travel distance is a distance from the input grid point to a grid point (next direction change point) passed last or reached last through the linear search in S23.

If the travel distance is shorter than the minimum curvature radius of the harness to be wired (No in S24), the distance between the input grid point and the next direction change point is short. Therefore, it is considered to be difficult to change the wiring direction of the harness by bending the harness along the basic route detected by the linear search unit 22. The linear search unit 22 thus determines that wiring the harness along the basic route is difficult. Thus, the linear search unit 22 does not adopt the linear search in the selected one axis direction, and proceeds to S28 to determine whether all six axis directions have been selected.

If some of the six axis directions are not yet selected (No in S28), the linear search unit 22 returns to S21. If all six axis directions are selected (Yes in S28), the linear search unit 22 returns to S15 in FIG. 4.

If the travel distance is equal to or longer than the minimum curvature radius of the harness to be wired (Yes in S24), the distance between the input grid point and the next direction change point is long enough to bend and wire the harness. It is thus considered to be possible to bend the harness along the basic route detected by the linear search unit 22 and change the wiring direction of the harness. The linear search unit 22 thus determines that wiring the harness along the basic route is possible.

The linear search unit 22 sets the grid point passed last or reached last in S23 and acquired in response to the detection of the surface of the obstacle to be the collision flag=“1” and the parent=the input grid point ID. The linear search unit 22 sets the grid point passed last or reached last in S23 and acquired in response to the detection of the border or detection of the intersection across the axis passing through the end point to be the collision flag=“0” and the parent=the input grid point ID. Also, the linear search unit 22 calculates the cost value of the grid point passed last or reached last in S23 (S25).

If a previously calculated cost value of the grid point detected by the linear search in S23 is stored, the linear search unit 22 determines whether the currently calculated cost value is lower than the stored cost value (S26).

The currently calculated cost value is lower than the stored cost value (Yes in S26), the linear search unit 22 stores the collision flag, the parent, and the cost value set or calculated in S25 as the grid point information 36 on the grid point detected in the linear search in S23. The linear search unit 22 inputs the grid point (grid point ID) detected in the linear search in S23 into the first check queue 37 (S27). The linear search unit 22 then proceeds to S28.

If no cost value is stored for the grid point detected in the linear search in S23, the linear search unit 22 proceeds to S27 without performing the comparison in S26.

If the currently calculated cost value is equal to or higher than the stored cost value (No in S26), the linear search unit 22 returns to a state prior to S25 without storing the collision flag, the parent, and the cost value, which are set or calculated in S25 (S29). The linear search unit 22 then proceeds to S28.

If the input grid point is set in response to the detection of the surface of an obstacle through the linear search, the collision flag of the input grid point is “1” (No in S22). In such a case, the linear search unit 22 performs the linear search from the input grid point in four directions perpendicular to the normal line to the surface of the obstacle at the location where the obstacle is detected (S30). The four normal line directions include two directions perpendicular to the normal line direction in a plane defined by the normal line direction and the linear search direction extending to the location where the input grid point is detected, and two directions perpendicular to the plane defined by the normal line direction and the linear search direction extending to the location where the input grid point is detected. The linear search unit 22 then performs the linear search until the minimum distance d between the surface of the obstacle and the route under search becomes equal to or longer than a predetermined distance, or to the end of the surface of the obstacle, or until a grid point at the location where the route intersects an axis passing through the end point.

If the route is spaced part from the surface of the detected obstacle by the predetermined distance, or the route reaches the end of the surface of the obstacle, or the route intersects an axis passing through the end point, the linear search unit 22 determines whether the travel distance is equal to or longer than the minimum curvature radius of the harness to be wired (S31). The travel distance is a distance from the input grid point to the grid point (next direction change point) reached through the linear search in S30.

If the travel distance is shorter than the minimum curvature radius (No in S31), the linear search unit 22 determines that wiring the harness along the basic route is difficult for the same reason as previously described. The linear search unit 22 shifts to S28 without adopting the current linear search, and then determines whether all six axis directions have been selected.

If the travel distance is equal to or longer than the minimum curvature radius (Yes in S31), the linear search unit 22 determines that changing the wiring direction of the harness along the basic route is possible for the same reason as previously described.

The linear search unit 22 sets the grid point reached through the linear search to be the collision flag=“0” and the parent=the input grid point ID. The linear search unit 22 calculates the cost value of the grid point reached through the linear search (S32). The linear search unit 22 then proceeds to S26.

The exception processing performed when the end point is unable to be reached in S20 in FIG. 4 is described with reference to a flowchart of FIG. 6. When the start point and the end point of a harness to be wired, and the first check queue 37 are input, the space recognition unit 23 of the computer 10 recognizes and generates a linear searched space in which the linear search has been performed, in other words, a space containing grid points all having cost values set therefor (S41). In the example described later with reference to FIG. 9, the linear searched space is a rectangular parallelepiped space.

The point-by-point search unit 24 initializes (set to be empty) the second check queue 38 (S42) into which search candidate grid points in the search performed by the point-by-point search unit 24 are to be input, and the point-by-point search unit 24 inputs the start point into the second check queue 38 (S43). The point-by-point search unit 24 sets the cost value=∞ and the parent=“none” in the grid point information 36 on the start point.

The point-by-point search unit 24 determines whether the second check queue 38 is empty (S44). If the second check queue 38 is empty (Yes in S44), the point-by-point search unit 24 determines whether the first check queue 37 is empty (S45). If the first check queue 37 is empty (Yes in S45), the computer 10 ends the route search with “no route present”.

If the first check queue 37 is not empty (No in S45), a grid point on a route extending from within the linear searched space to outside the linear searched space is input in the first check queue 37. In such a case, the computer 10 returns to the processing performed by the linear search unit 22 in S15 in FIG. 4.

If the second check queue 38 is not empty (No in S44), the point-by-point search unit 24 picks up a grid point from the second check queue 38 (S46). The point-by-point search unit 24 determines whether the picked-up grid point is the end point (S47).

If the picked-up grid point is not the end point (No in S47), the point-by-point search unit 24 checks an area surrounding the picked-up grid point, and inputs grid points accessible from the picked-up grid point into the first check queue 37 or the second check queue 38 (S48). If there is no grid point accessible from the picked-up grid point, input of the grid points into the first check queue 37 or the second check queue 38 is not performed. The point-by-point search unit 24 then returns to S44. The check (exception processing) in S48 is described later in detail with reference to FIG. 7.

If the picked-up grid point is the end point (Yes in S47), the point-by-point search unit 24 traces back the basic route from the end point by tracing the parents in the grid point information 36, acquires the basic route from the start point to the end point, and outputs the basic route (S49). The point-by-point search unit 24 ends the route search with “route present”. In S49, the user may manually adjust the acquired basic route as appropriate.

The check (exception processing) of an accessible grid point, which is performed on each grid point to be checked (search candidate) in S48 in FIG. 6, is described with reference to a flowchart of FIG. 7.

When a grid point (grid point to be checked) that is not the end point picked up in S46 in FIG. 6 is input as an input grid point, the point-by-point search unit 24 selects one axis direction from the six axis directions of the orthogonal grid (fore-aft, lateral, and vertical directions) as a direction in which the search proceeds from the input grid point (S51).

The point-by-point search unit 24 determines whether a neighboring grid point adjacent in the direction selected in S51 is accessible from the input grid point (S52). If the neighboring grid point is not accessible (No in S52), the point-by-point search unit 24 proceeds to S57, and determines whether all six axis directions have been selected. If some of the six axis directions have not yet been selected (No in S57), the point-by-point search unit 24 returns to S51. If all six axis directions have been selected (Yes in S57), the point-by-point search unit 24 returns to S44 in FIG. 6.

If the neighboring grid point in the direction selected in S51 is accessible from the input grid point (Yes in S52), the point-by-point search unit 24 determines whether the grid point as the neighboring grid point is within the linear searched space generated in S41 (S53). More specifically, the point-by-point search unit 24 determines whether the neighboring grid point accessible from the input grid point is present within the linear searched space (rectangular parallelepiped space).

If the neighboring grid point is present within the linear searched space (Yes in S53), the point-by-point search unit 24 calculates the cost value of the grid point, and sets the parent=the input grid point ID (S54).

If the previously calculated cost value of the neighboring grid point is stored, the point-by-point search unit 24 determines whether the currently calculated cost value is lower than the stored cost value (S55).

If the currently calculated cost value is lower than the stored cost value (Yes in S55), the point-by-point search unit 24 stores the parent and the cost value, which are set or calculated in S54, as the grid point information 36 on the neighboring grid point. The point-by-point search unit 24 inputs the neighboring grid point (grid point ID) as a search candidate of the search performed by the point-by-point search unit 24 into the second check queue 38 (S56). The point-by-point search unit 24 then proceeds to S57.

If the previously calculated cost value is not stored for the neighboring grid point, the point-by-point search unit 24 proceeds to S56 without performing the comparison in S55.

If the currently calculated cost value is equal to or higher than the stored cost value (No in S55), the point-by-point search unit 24 returns to a state prior to S54 without storing the parent and the cost value, which are set or calculated in S54 (S58). The point-by-point search unit 24 then proceeds to S57.

If the neighboring grid point is not present within the linear searched space, in other words, the neighboring grid point is present outside the linear searched space (No in S53), the point-by-point search unit 24 calculates the cost value of the neighboring grid point, and sets the parent=the input grid point ID (S59).

The point-by-point search unit 24 stores the parent and the cost value, which are set or calculated in S59, as the grid point information 36 on the neighboring grid point. The point-by-point search unit 24 also inputs the neighboring grid point (grid point ID) into the first check queue 37 as a search candidate of the search performed by the linear search unit 22 (S60). The point-by-point search unit 24 then proceeds to S57.

If a grid point on the route extending from within the linear searched space to outside the linear searched space, namely, a neighboring grid point (eighth grid point) outside the linear searched space is not detected, both the first check queue 37 and the second check queue 38 are in an empty state. The second check queue 38 and the first check queue 37 are determined to be empty respectively in S44 and S45 in FIG. 6, and the computer 10 ends the route search with “no route present”. In this case, the display unit 50 or the like may notify the user that there is no route extending from within the linear searched space to outside the linear searched space.

Next, storage contents of search candidates (grid points to be checked) in the first check queue 37 according to the embodiment are specifically described with reference to FIG. 8A through FIG. 8C. In FIG. 8A through FIG. 8C, a 4×4 orthogonal grid is arranged between two obstacles, 16 grid points are tagged with grid point IDs A through P, and the orthogonal grid in a 3D space is represented in a two-dimensional fashion.

As illustrated in FIG. 8A, search candidate grid points F and C are stored in the first check queue 37, and it is assumed that the search candidate grid point F is selected from the first check queue 37. In FIG. 8A, the search candidate grid point F is set to be the parent=the grid point B, the cost value=3, and the collision flag=“0” in the grid point information 36. Similarly, the search candidate grid point C is set to be the parent=the grid point B, the cost value=4, and the collision flag=“0” in the grid point information 36.

When the search candidate grid point F is selected from the first check queue 37 as illustrated in FIG. 8A (see S16 and the No in S17 in FIG. 4), an area surrounding the search candidate grid point F is checked (see S18 in FIG. 4 and FIG. 5) as illustrated in FIG. 8B. Since the parent of the grid point F is the grid point B, the linear search is performed from the grid point F in three directions (directions to grid points E, G, and J) other than the upward direction (direction to the grid point B).

When the linear search proceeds in the leftward direction (in the direction to the grid point E), the obstacle is detected prior to the arrival at the neighboring grid point E, and the leftward travel is determined to be difficult.

When the linear search proceeds in the rightward direction (in the direction to the grid point G), the surface of the obstacle is detected after passing through the grid point G. The grid point G passed immediately prior to the detection of the surface of the obstacle is recognized as one of the grid points (next direction change points) accessible from the grid point F.

When the linear search proceeds in the downward direction (in the direction to the grid point J), the obstacle is detected subsequent to passing through the grid point N. The grid point N passed immediately prior to the detection of the obstacle is recognized as one of the grid points (next direction change points) accessible from the grid point F.

The grid points N and G thus recognized are input as the search candidates in the first check queue 37 as illustrated in FIG. 8C. The grid point N is set to be the parent=the grid point F, the cost value=5, and the collision flag=“0” in the grid point information 36, and the grid point G is set to be the parent=the grid point F, the cost value=4, and the collision flag=“1”.

If the grid point information 36 (cost value and the like) on the grid points N and G is already stored, the currently acquired cost value is compared with the stored cost value (see S26 in FIG. 5). If the currently acquired cost value is lower than the stored cost value, new grid point information 36 is stored.

A state in which the route search according to the embodiment is unable to reach the end point and the exception processing performed when such a state occurs are described below with reference to FIG. 9.

An obstacle in FIG. 9 includes an internal space communicating with an external space through an opening (near a grid point P9). It is assumed that the linear search as illustrated in FIG. 4 and FIG. 5 is performed with the start point present in the internal space of the obstacle and the end point present in the external space.

When the linear search proceeds from the start point, the internal surface of the obstacle is detected, thus grid points A, B, and C are detected as next direction change points and information thereon is input in the first check queue 37. When the linear search proceeds from each of the grid points A, B, and C, the internal surface of the obstacle is detected, and grid points D and E are detected as next direction change points and information thereon is input in the first check queue 37. When the linear search proceeds from each of the grid points D and E, the internal surface of the obstacle is detected. Since the cost value (travel distance) of each detected grid point exceeds the cost value stored therefor, information on the grid points D and E are not input in the first check queue 37. Thus, the first check queue 37 becomes empty, that is, the computer 10 (linear search unit 22) falls in a state unable to reach the end point by the linear search.

When the first check queue 37 becomes empty (No in S15 in FIG. 4), the exception processing described with reference to FIG. 6 and FIG. 7 is performed by the space recognition unit 23 and the point-by-point search unit 24 (see S20 in FIG. 4).

With respect to the obstacle in FIG. 9, the space recognition unit 23 recognizes and generates a space containing all grid points (the start point and the grid points A through E in FIG. 9) with the cost values set therefor, as a linear searched space (rectangular parallelepiped space) in which the space recognition unit 23 has completed the linear search (see S41 in FIG. 6).

The point-by-point search unit 24 searches the linear searched space recognized by the space recognition unit 23, one by one, for neighboring grid points accessible from the start point using the second check queue 38 (see FIG. 6 and FIG. 7), and determines whether the detected neighboring grid point is within the linear searched space (see S53 in FIG. 7).

The neighboring grid point (grid point P9 in FIG. 9) determined to be outside the linear searched space is set to be a grid point on a route extending from within the linear searched space to outside the linear searched space, and is input as a search candidate to be checked by the linear search unit 22 (see S59 and S60 in FIG. 7). As a result, the first check queue 37 becomes non-empty.

When the first check queue 37 is non-empty while the second check queue 38 is empty, specifically in the example of FIG. 9, the grid point P9 on the route extending from within the linear searched space to outside the linear searched space has been input in the first check queue 37. With this, the linear search unit 22 resumes the linear search from the grid point P9 in the external space, and searches the basic route reaching the end point through the processing in S15 through S19 in FIG. 4 and FIG. 5.

Next, another state is considered in which the start point and the end point are reversed in FIG. 9, in other words, the end point is present in the internal space of the obstacle and the start point is present in the external space. The grid point P9 is not detected in this case either, and the computer 10 (linear search unit 22) falls in a state unable to reach the end point. The space recognition unit 23 and the point-by-point search unit 24 perform the exception processing, thereby detecting the route from the start point in the linear searched space (external space of the obstacle) to the grid point P9. The linear search unit 22 resumes the linear search from the grid point P9 in the internal space and detects the basic route to the end point.

The information processing apparatus 10 having the route search function according to the embodiment partitions, in a 3D CAD, a space having an obstacle therein into an orthogonal grid to search the space for a route from a start point to an end point. The information processing apparatus 10 proceeds straight until the obstacle or the border is detected. The information processing apparatus 10 performs the linear search for detecting a route by detecting a grid point close to the obstacle or a grid point avoiding the obstacle, and thus searches for the route from the start point to the end point.

More specifically, a grid point that is detected by performing the linear search at once to the detection of the obstacle or the border is set to be a direction change point. The embodiment searches only for the direction change points, and reduces the number of searches for the grid points in comparison with the technique that searches for the route by checking the neighboring grid points one by one. Thus, the embodiment reduces the amount of processing for the route search from the start point to the end point.

If the surface of the obstacle not in parallel with the grid (such as a curve or a slope) is detected, the route search is performed in a direction perpendicular to the normal line direction to the surface of the obstacle until the route is spaced apart from the surface of the obstacle by a predetermined distance. In this way, the route search is performed by selecting only the grid point close to the obstacle but reliably enabled to avoid the obstacle. In other words, a grid point around the surface of the obstacle is dynamically set to be a direction change point. Even if the grid interval is small or the surface of the obstacle is not parallel with the grid, the amount of processing used to perform the route search from the start point to the end point may be reduced.

According to the embodiment, interactive performance in searching the route from the start point to the end point is increased. In particular, when the grid interval is small, or the surface of the obstacle is not parallel with the grid, the interactive performance is increased considerably. The use of the route search technique according to the embodiment reduces the processing time and increases the interactive performance in the routing of the wiring in a notebook PC or an electronic apparatus, each having a compact space.

If the route under search fails to reach the end point in the linear search as illustrated in FIG. 9 according to the embodiment, the linear searched space having undergone the linear search is recognized in the exception processing, and the neighboring grid points accessible from the start point in the linear searched space are checked one by one. A grid point on the route extending from within the linear searched space to outside the linear searched space is searched for by determining whether a checked neighboring grid point is in the linear searched space. The linear search resumes, starting with the grid point thus detected.

With this, the information processing apparatus 10 may leave the state of being unable to reach the end point, which may occur in the linear search. Thus, even if the linear search is employed, the route search is reliably performed from the start point to the end point.

In the linear search according to the embodiment, a distance traveled by a single linear search may vary from linear search to linear search. If the travel distance is short, the wiring direction of the harness may be difficult to be changed by bending the harness along the searched basic route. According to the embodiment, it is determined whether the distance traveled by a single linear search is equal to or longer than the minimum curvature radius of the harness.

If the travel distance is shorter than the minimum curvature radius of the harness, it is likely that wiring the harness along the basic route is difficult. Therefore, the linear search having the travel distance shorter than the minimum curvature radius is not used. On the other hand, if the travel distance is equal to or longer than the minimum curvature radius of the harness, the travel distance is long enough to wire the harness with bending. The harness may be thus wired along the basic route. According to the embodiment, the basic route that allows the harness to be wired reliably is thus searched for.

The embodiment has been described in detail. The embodiment is not limited to the techniques described above. A variety of changes and modifications are possible to the embodiment without departing from the scope according to the embodiment.

The embodiment has been described with reference to the example in which the orthogonal grid in the 3D space is two-dimensionally represented. The technique of the route search according to the embodiment is equally applicable to the case in which the orthogonal grid is three-dimensionally represented, and the advantageous effects according to the embodiment are similarly achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium having stored therein a program that causes a computer to execute a process, the process comprising:
partitioning a three-dimensional space into an orthogonal grid;
performing a linear search of searching for a last linear portion of a route proceeding from a start point of the route, the linear search being performed starting with a first grid point of the orthogonal grid or a second grid point of the orthogonal grid, the first grid point being set to be the start point, the second grid point being one of direction change points where the route changes a proceeding direction thereof, the last linear portion linearly proceeding from the first grid point or the second grid point in one direction until an obstacle is detected; and
adding a third grid point of the orthogonal grid to the direction change points, the third grid point being passed through by the last linear portion immediately prior to the detection of the obstacle.

2. The computer-readable recording medium according to claim 1, the process further comprising:
adding a fifth grid point of the orthogonal grid to the direction change points, the fifth grid point being detected at a location where the last linear portion intersects an axis of the orthogonal grid, the axis passing through a fourth grid point of the orthogonal grid, the fourth grid point being set to be an end point of the route.

3. The computer-readable recording medium according to claim 1, the process further comprising:
performing the linear search starting with the third grid point in a first direction perpendicular to a normal line direction to a surface of the obstacle at a location where the obstacle has been detected until a minimum distance between the surface and the last linear portion is equal to or longer than a predetermined distance; and
adding a fourth grid point of the orthogonal grid to the direction change points when a first minimum distance is equal to or longer than the predetermined distance, the fourth grid point having a second minimum distance to the surface, the second minimum distance being equal to or longer than the predetermined distance, the fourth grid point being in a region defined to be close to a first location in the first direction, the first location having the first minimum distance between the surface.

4. The computer-readable recording medium according to claim 3, the process further comprising:
adding a fifth grid point of the orthogonal grid to the direction change points when the first minimum distance remains shorter than the predetermined distance through the linear search, the fifth grid point being in a region defined to be close to a location at which the last linear portion has reached through the linear search.

5. The computer-readable recording medium according to claim 1, the process comprising:
adding the third grid point to the direction change points when a length of the last linear portion is equal to or longer than a predetermined length set depending on a minimum curvature radius of a harness wired along the route.

6. The computer-readable recording medium according to claim 1, the process further comprising:
recognizing, if the route fails to reach a fourth grid point of the orthogonal grid through the linear search, a linear searched space that has undergone the linear search, the fourth grid point being set to be an end point of the route;
checking a neighboring grid point accessible from the start point in the linear searched space;
determining whether the neighboring grid point is within the linear searched space;
adding the neighboring grid point to the direction change points when the neighboring grid point is determined to be outside the linear searched space; and
resuming the linear search starting with the neighboring grid point.

7. An information processing apparatus, comprising:
a storage unit configured to
store therein information on an obstacle present within a three-dimensional space; and
a processor configured to
partition the three-dimensional space into an orthogonal grid,
perform, on basis of the information stored in the storage unit, a linear search of searching for a last linear portion of a route proceeding from a start point of the route, the linear search being performed starting with a first grid point of the orthogonal grid or a second grid point of the orthogonal grid, the first grid point being set to be the start point, the second grid point being one of direction change points where the route changes a proceeding direction thereof, the last linear portion linearly proceeding from the first grid point or the second grid point in one direction until the obstacle is detected, and
add a third grid point of the orthogonal grid to the direction change points, the third grid point being passed by the last linear portion through immediately prior to the detection of the obstacle.

8. The information processing apparatus according to claim 7, wherein the processor is further configured to
add a fifth grid point of the orthogonal grid to the direction change points, the fifth grid point being detected at a location where the last linear portion intersects an axis of the orthogonal grid, the axis passing through a fourth grid point of the orthogonal grid, the fourth grid point being set to be an end point of the route.

9. The information processing apparatus according to claim 7, wherein the processor is further configured to
perform the linear search starting with the third grid point in a first direction perpendicular to a normal line direction to a surface of the obstacle at a location where the obstacle has been detected until a minimum distance between the surface and the last linear portion is equal to or longer than a predetermined distance, and
add a fourth grid point of the orthogonal grid to the direction change points when a first minimum distance is equal to or longer than the predetermined distance, the fourth grid point having a second minimum distance to the surface, the second minimum distance being equal to or longer than the predetermined distance, the fourth grid point being in a region defined to be close to a first location in the first direction, the first location having the first minimum distance between the surface.

10. The information processing apparatus according to claim 9, wherein the processor is further configured to
add a fifth grid point of the orthogonal grid to the direction change points when the first minimum distance remains shorter than the predetermined distance through the linear search, the fifth grid point being in a region defined to be close to a location at which the last linear portion has reached through the linear search.

11. The information processing apparatus according to claim 7, wherein the processor is configured to
add the third grid point to the direction change points when a length of the last linear portion is equal to or longer than a predetermined length set depending on a minimum curvature radius of a harness wired along the route.

12. The information processing apparatus according to claim 7, wherein the processor is further configured to
recognize, if the route fails to reach a fourth grid point of the orthogonal grid through the linear search, a linear searched space that has undergone the linear search, the fourth grid point being set to be an end point of the route,
check a neighboring grid point accessible from the start point in the linear searched space,
determine whether the neighboring grid point is within the linear searched space,
add the neighboring grid point to the direction change points when the neighboring grid point is determined to be outside the linear searched space; and
resume the linear search starting with the neighboring grid point.

13. A route search method, comprising:
partitioning, by a computer, a three-dimensional space into an orthogonal grid;
performing a linear search of searching for a last linear portion of a route proceeding from a start point of the route, the linear search being performed starting with a first grid point of the orthogonal grid or a second grid point of the orthogonal grid, the first grid point being set to be the start point, the second grid point being one of direction change points where the route changes a proceeding direction thereof, the last linear portion linearly proceeding from the first grid point or the second grid point in one direction until an obstacle is detected; and
adding a third grid point of the orthogonal grid to the direction change points, the third grid point being passed through by the last linear portion immediately prior to the detection of the obstacle.

14. The route search method according to claim 13, further comprising;
adding a fifth grid point of the orthogonal grid to the direction change points, the fifth grid point being detected at a location where the last linear portion intersects an axis of the orthogonal grid, the axis passing through a fourth grid point of the orthogonal grid, the fourth grid point being set to be an end point of the route.

15. The route search method according to claim 13, further comprising:
performing the linear search starting with the third grid point in a first direction perpendicular to a normal line direction to a surface of the obstacle at a location where the obstacle has been detected until a minimum distance between the surface and the last linear portion is equal to or longer than a predetermined distance; and
adding a fourth grid point of the orthogonal grid to the direction change points when a first minimum distance is equal to or longer than the predetermined distance, the fourth grid point having a second minimum distance to the surface, the second minimum distance being equal to or longer than the predetermined distance, the fourth grid point being in a region defined to be close to a first location in the first direction, the first location having the first minimum distance between the surface.

16. The route search method according to claim 15, further comprising:
adding a fifth grid point of the orthogonal grid to the direction change points when the first minimum distance remains shorter than the predetermined distance through the linear search, the fifth grid point being in a region defined to be close to a location at which the last linear portion has reached through the linear search.

17. The route search method according to claim 13, comprising:
adding the third grid point to the direction change points when a length of the last linear portion is equal to or longer than a predetermined length set depending on a minimum curvature radius of a harness wired along the route.

18. The route search method according to claim 13, further comprising:
recognizing, if the route fails to reach a fourth grid point of the orthogonal grid through the linear search, a linear searched space that has undergone the linear search, the fourth grid point being set to be an end point of the route;
checking a neighboring grid point accessible from the start point in the linear searched space;
determining whether the neighboring grid point is within the linear searched space;
adding the neighboring grid point to the direction change points when the neighboring grid point is determined to be outside the linear searched space; and
resuming the linear search starting with the neighboring grid point.
